(19) United States
(12) Patent Application Publication
(10) Pub. No.: US 2010/0301293 A1
(43) Pub. Date: Dec. 2, 2010

(54) HOIST LOCKING MECHANISM

(75) Inventor: Jeremia Petrus Venter, Gauteng (ZA)

Correspondence Address: JAMES EARL LOWE, JR., 15417 W NATIONAL AVE # 300, NEW BERLIN, WI, 53151, US

(73) Assignee: JOY MM DELAWARE, Wilmington, DE (US)

(21) Appl. No.: 12/475,454

(22) Filed: May 29, 2009

(51) Int. Cl. B66F 3/08

(52) U.S. Cl. 254/93 A

(57) ABSTRACT

A cylinder assembly for supporting a device above a surface, the device including a base, the cylinder assembly including a cylinder, mounted on the base, and extendable perpendicular to the base. The cylinder assembly further includes a foot at the end of the cylinder away from the base, and a locking mechanism for locking the cylinder in its fully extended position, the locking mechanism comprising a track attached to the base, and a track rod connected to and movable along the track, between a cylinder retraced position and a cylinder extended position. The locking mechanism also includes a brace pivotally attached at one end to the track rod, and pivotally attached at another end to the foot, and a fixing mechanism for fixing the track rod in the cylinder extended position.

### BACKGROUND

This disclosure relates to a device including a cylinder assembly for supporting the device above a surface, and a locking mechanism for locking the cylinder assembly in the cylinder extended position.

On some devices, such as mobile machines, and especially shuttle cars used in mining applications, the devices include a mechanism for raising the device above the surface, usually for maintenance purposes. The mechanism often takes the form of an extendable cylinder. Currently, no means is provided for preventing the collapse of the extended cylinder in the event of a loss of hydraulic pressure.

### SUMMARY

In order to help prevent accidental collapse of the extended cylinder, this disclosure provides a mechanism for locking the extended cylinder in its extended position.

In this disclosure, there is provided a cylinder assembly for supporting a device above a surface, the device including a base, the cylinder assembly including a cylinder, mounted on the base, and extendable perpendicular to the base. The cylinder assembly further includes a foot at the end of the cylinder away from the base, and a locking mechanism for locking the cylinder in its fully extended position, the locking mechanism comprising a track attached to the base, and a track rod connected to and movable along the track, between a cylinder retraced position and a cylinder extended position. The locking mechanism also includes a brace pivotally attached at one end to the track rod, and pivotally attached at another end to the foot, and a fixing mechanism for fixing the track rod in the cylinder extended position.

### BRIEF DESCRIPTION OF THE DRAWINGS

FIG. 1 is a side perspective view of a device including a cylinder assembly for supporting the device above a surface, the cylinder assembly being shown in a partially extended position.

FIG. 2 is a side perspective view of the device shown in FIG. 1, the cylinder assembly being shown in a fully extended, but unlocked, position.

FIG. 3 is rear view, taken from behind and below the base of the device, showing the cylinder assembly in a fully extended, locked, position.

FIG. 4 is a side perspective view of of the device shown in FIG. 1, the cylinder assembly being shown in a fully extended, locked, position.

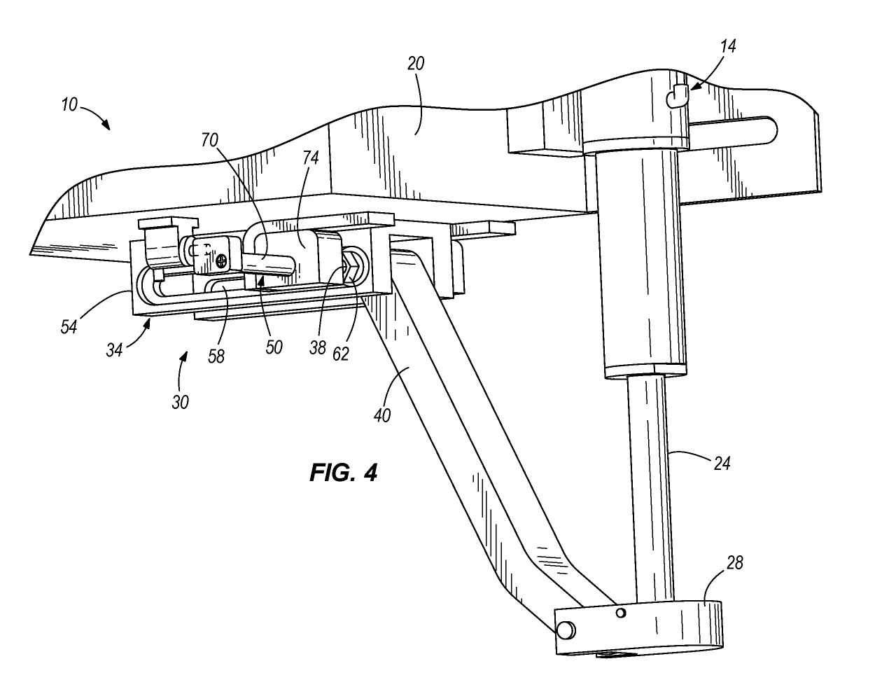

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DESCRIPTION OF THE PREFERRED EMBODIMENT

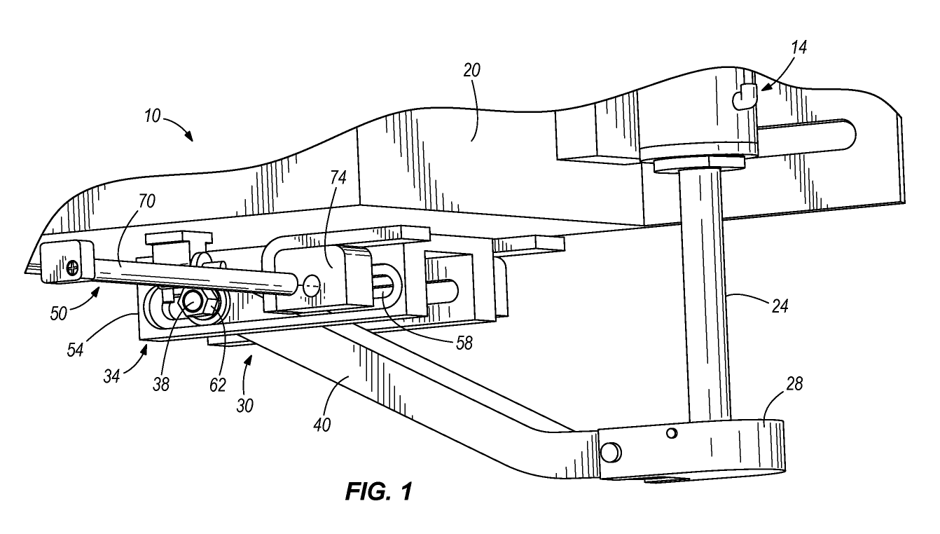

FIG. 1 is a side perspective view of a device 10 including a cylinder assembly 14 for supporting the device 10 above a surface (not shown), the cylinder assembly 14 being shown in a partially extended position. In the illustrated embodiment, the device 10 is a shuttle car used in underground mining.

The device 10 includes a base 20, in the form of the bottom surface of the shuttle car, and the cylinder assembly 14 includes an extendable hydraulic cylinder 24, mounted on the base 20, and extendable perpendicular to the base 20. The cylinder assembly 14 further includes a foot 28 at the end of the cylinder away from the base 20. In the illustrated embodiment, the foot 28 is a separate piece attached to the end of the cylinder 14, but in other embodiments (not shown), the foot can be just the end of the cylinder 14.

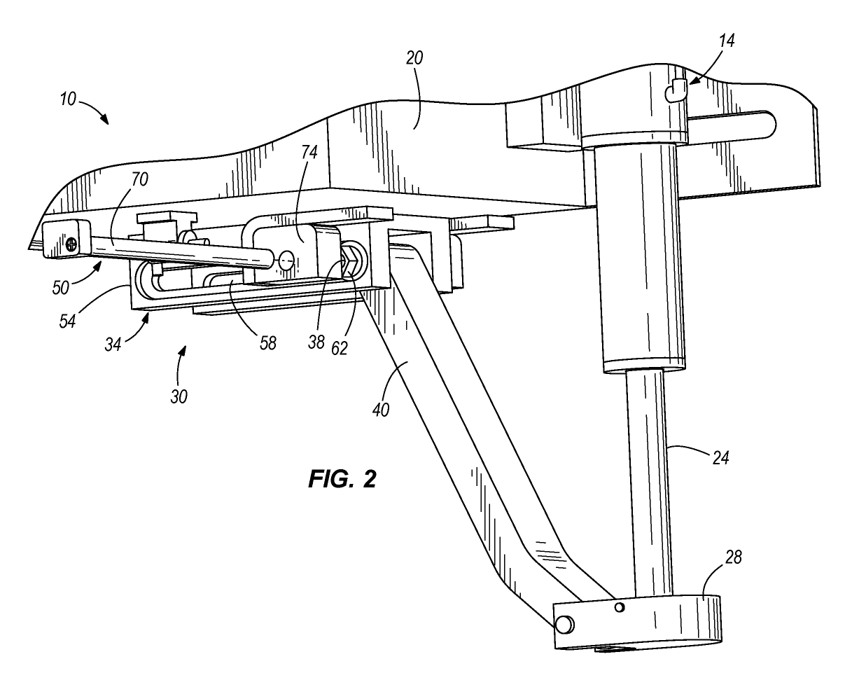

The cylinder assembly 14 also includes a locking mechanism 30 for locking the cylinder 24 in its fully extended position, the locking mechanism 30 comprising a track 34 attached to the base 20, and a track rod 38 connected to and movable along the track 34, between a cylinder retraced position, at the far left end of the track 34 shown in FIG. 1, and a cylinder extended position, at the far right end of the track 34, as shown in FIG. 2. The locking mechanism 30 also includes a brace 40 pivotally attached at one end to the track rod 38, and pivotally attached at another end to the foot 28, and a fixing mechanism 50 for fixing the track rod 38 in the cylinder extended position.

More particularly, the track 34 includes two spaced apart, parallel plates 54, each plate 54 being attached on one side to the base 20, and each plate 54 having a slot 58 extending along the plate 54 from near one end of the plate to the other end of the plate. The track rod 38 extends through the slots 58 in the plates 54, and the track rod 38 includes an end with an enlarged end 62, and the track rod 38 other end includes an enlarged end (not shown). More particularly, each of the enlarged ends 62 is a nut threaded on the rod end.

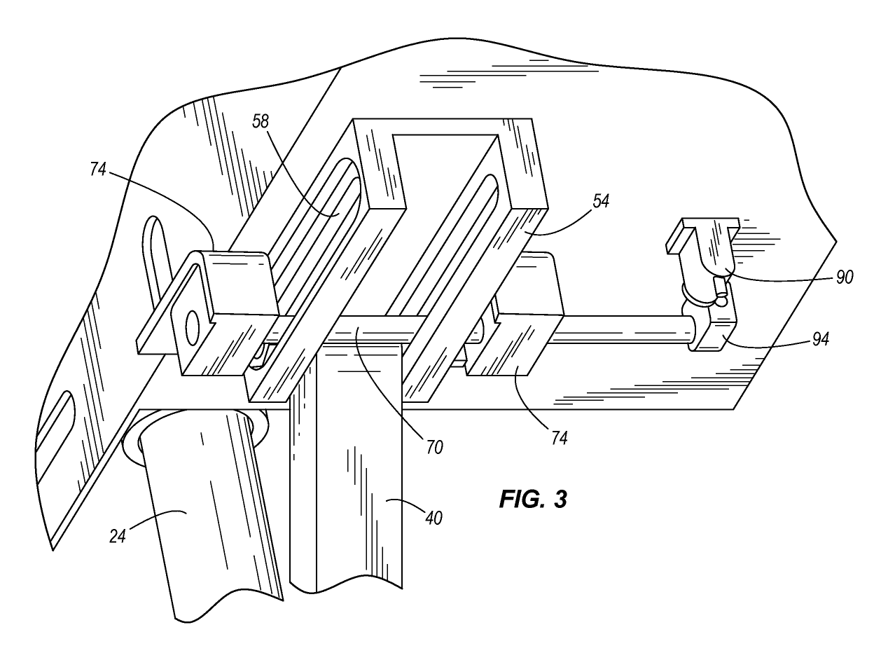

The fixing mechanism 50 comprises a locking rod 70, a pair of spaced apart locking lugs 74 attached to the base 20, with one on one side of the track and another on the other side of the track, each locking lug 74 having a locking rod receiving opening 78, the locking rod 70 being adapted to extend through each of the locking lugs 74, and adapted to be positioned to engage the track rod 38 and prevent movement of the track rod 38 from the cylinder extended position to the cylinder retracted position. The locking rod 70 is in the slot 58, and aside the track rod 38, as shown in FIG. 3.

In the preferred embodiment, the device 10 also includes means for locking the locking rod 70 in the locking lugs 74. In the illustrated embodiment, the means for locking the locking rod is in the form of a electromagnet 90 (see FIG. 3), which can be switched on to hold the susceptible end 94 of the locking rod 70 in its locked position.

In operation, the device 10 works as follows. The extendable cylinder would be retracted. When it is desired to support the device in the raised position, then the cylinder 24 is extended. The cylinder is shown partially extended in FIG. 1, and fully extended in FIG. 2. When fully extended, the foot 28 at the end of the cylinder engages the surface, and the cylinder supports the device in its raised position, usually so maintenance can be done on the device.

Once fully extended, the cylinder 24 is locked in place by the locking mechanism 30. Before the cylinder is extended, the track rod 38 is in the far left position, close to as shown in FIG. 1. As the cylinder 24 becomes fully extended, the track rod 38 moves to the far right position, as shown in FIG. 2. When in the far right position, the track rod 38 is located to the right of the lugs 74. The locking rod 70 then passes through the lugs and through the track slots 58, adjacent the brace 40, so that the brace 40 is held in the far right position by the locking rod 70 on the left, and the end of the track slot 58 on the right. In other embodiments (not shown), the locking rod 70 can pass through an opening in the brace 40 or the track rod 38. When it is desired to unlock the extended cylinder 24, the locking rod 70 is removed from the lugs 74, so that the track rod 38 can then move to the left along the track 34.

Various other features of this disclosure are set forth in the following claims.

1. A device including a cylinder assembly for supporting said device above a surface, the device including
a base, and said cylinder assembly including
a cylinder, mounted on said base, and extendable perpendicular to said base,
a foot at the end of the cylinder away from said base, and
locking means for locking said cylinder in its fully extended position, said locking means comprising
a track attached to said base,
a track rod connected to and movable along said track, between a cylinder retraced position and a cylinder extended position,
a brace pivotally attached at one end to said track rod, and pivotally attached at another end to said foot, and
fixing means for fixing said track rod in said cylinder extended position.

2. A device in accordance with claim 1 wherein said track includes two spaced apart, parallel plates, each plate being attached on one side to said base, and each plate having a slot extending along said plate from near one end of said plate to the other end of said plate.

3. A device in accordance with claim 2 wherein said track rod extends through the slots in said plates.

4. A device in accordance with claim 3 wherein said track rod includes an end with an enlarged end, and wherein said track rod other end includes an enlarged end.

5. A device in accordance with claim 4 wherein said enlarged end is a nut threaded on said rod end.

6. A device including a cylinder assembly for supporting said device above a surface, the device including
a base, and said cylinder assembly including
a cylinder, mounted on said base, and extendable perpendicular to said base,
a foot at the end of the cylinder away from said base, and
locking means for locking said cylinder in its fully extended position, said locking means comprising
a track attached to said base,
a track rod connected to and movable along said track, between a cylinder retraced position and a cylinder extended position,
a brace pivotally attached at one end to said track rod, and pivotally attached at another end to said foot,
a locking rod,
a pair of spaced apart locking lugs attached to said base, with one on one said of said track and another on the other side of said track, each locking lug having a locking rod receiving opening,
said locking rod being adapted to extend through each of said locking lugs, and adapted to be positioned to engage said track rod and prevent movement of said track rod from said cylinder extended position to said cylinder retracted position.

7. A device in accordance with claim 6 wherein said track includes two spaced apart, parallel plates, each plate being attached on one side to said base, and each plate having a slot extending along said plate from near one end of said plate to the other end of said plate.

8. A device in accordance with claim 7 wherein said track rod extends through the slots in said plates.

9. A device in accordance with claim 8 wherein said track rod includes an end with an enlarged end, and wherein said track rod other end includes an enlarged end.

10. A device in accordance with claim 9 wherein said enlarged end is a nut threaded on said rod end.

11. A device in accordance with claim 6 wherein said locking rod is in said slot, and aside said track rod.

12. A device in accordance with claim 6 and further including means for locking said locking rod in said locking lugs.
